(19) United States
(12) Patent Application Publication
(10) Pub. No.: US 2024/0242085 A1
(43) Pub. Date: Jul. 18, 2024

(54) METHOD FOR TRAINING DEEP LEARNING MODEL USING SELF-KNOWLEDGE DISTILLATION ALGORITHM, INFERRING APPARATUS USING DEEP LEARNING MODEL, AND STORAGE MEDIUM STORING INSTRUCTIONS TO PERFORM METHOD FOR TRAINING DEEP LEARNING MODEL

(71) Applicant: Research & Business Foundation SUNGKYUNKWAN UNIVERSITY, Suwon-si (KR)

(72) Inventors: Simon Sungil WOO, Suwon-si (KR); Jeongho KIM, Suwon-si (KR)

(73) Assignee: Research & Business Foundation SUNGKYUNKWAN UNIVERSITY, Suwon-si (KR)

(21) Appl. No.: 18/410,272

(22) Filed: Jan. 11, 2024

(30) Foreign Application Priority Data
Jan. 12, 2023 (KR) 10-2023-0004541

(51) Int. Cl. G06N 3/096

(52) U.S. Cl. CPC G06N 3/096

(57) ABSTRACT

There is provided a deep learning model training method using a self-knowledge distillation algorithm. The method comprises inputting training data to a deep learning model at a first time to obtain first output vectors and inputting the training data to the deep learning model at a second time before the first time to obtain second output vectors; generating soft target vectors at the first time point with respect to the training data using the second output vectors and label data; sorting the first output vectors and the soft target vectors and generating a first partial distribution for the sorted first output vectors and a second partial distribution for the sorted soft target vectors; and training the deep learning model to minimize a first loss function determined on the basis of the first partial distribution and the second partial distribution.

### TECHNICAL FIELD

The present disclosure relates to a method of training a deep learning model, and in particular, to a method of training a deep learning model using a self-knowledge distillation algorithm.

This work was supported by Institute of Information & communications Technology Planning & Evaluation (IITP) grant funded by Korea government (MSIT; Ministry of Science and ICT)(Research for Low-Power, High-Performance Object Detection Technology under Conditions of Degraded Video Quality (No. 2021-0-02309) and Convergence Security Graduate School Supporting Program (No. 2022-0-01199)).

### BACKGROUND

It is easy to train deep learning models well in fields in which a lot of data is secured. However, it is difficult to train deep learning models well in fields in which there is insufficient data, and recently, knowledge distillation through transfer learning has been attracting attention to solve this problem.

Knowledge distillation refers to transferring knowledge from a teacher network that has been well-trained in advance to a student network that is actually intended to be used.

In this regard, the prior art discloses self-knowledge distillation using prediction results of a deep learning model corresponding to the number of times of previous learning in the learning process of the deep learning model, but since there is a significant difference between the value with the highest confidence (or prediction certainty) and the value with the lowest confidence, there is a limitation in that knowledge about low confidence is ignored.

Therefore, there is a need to develop a method of improving the performance of deep learning models by learning without ignoring knowledge about low confidence in self-knowledge distillation.

### SUMMARY

An object of the present disclosure is to provide a deep learning model training method using a self-knowledge distillation algorithm, the method comprising inputting training data to a deep learning model at a first time to obtain first output vectors and inputting the training data to the deep learning model at a second time before the first time to obtain second output vectors; generating soft target vectors at the first time point with respect to the training data using the second output vectors and label data; sorting the first output vectors and the soft target vectors and generating a first partial distribution for the sorted first output vectors and a second partial distribution for the sorted soft target vectors; and training the deep learning model to minimize a first loss function determined on the basis of the first partial distribution and the second partial distribution.

The aspects of the present disclosure are not limited to the foregoing, and other aspects not mentioned herein will be clearly understood by those skilled in the art from the following description.

In accordance with an aspect of the present disclosure, there is provided a deep learning model training method using a self-knowledge distillation algorithm, the method comprises: inputting training data to a deep learning model at a first time to obtain first output vectors and inputting the training data to the deep learning model at a second time before the first time to obtain second output vectors; generating soft target vectors at the first time point with respect to the training data using the second output vectors and label data; sorting the first output vectors and the soft target vectors and generating a first partial distribution for the sorted first output vectors and a second partial distribution for the sorted soft target vectors; and training the deep learning model to minimize a first loss function determined on the basis of the first partial distribution and the second partial distribution.

Herein, a number of times of training the deep learning model at the first time and a number of times of training the deep learning model at the second time may be different from each other.

Additionally, the generating the first partial distribution and the second partial distribution may include sorting the soft target vectors on the basis of confidence scores for multiclass classification; and sorting the first output vectors in the same order as a class order of the sorted soft target vectors.

Additionally, the generating the first partial distribution and the second partial distribution may include generating the first partial distribution and the second partial distribution by dividing all classes included in the first output vectors and the soft target vectors by a preset number of classes.

Additionally, the deep learning model training method further comprises generating a first partial probability distribution and a second partial probability distribution from the first partial distribution and the second partial distribution using a softmax function.

Herein, the first loss function may be determined on the basis of the difference between the first partial probability distribution and the second partial probability distribution.

Additionally, the training the deep learning model may include determining a second loss function on the basis of the overall distributions of the first output vectors and the soft target vectors; and training the deep learning model to minimize a third loss function corresponding to a weighted sum of the first loss function and the second loss function.

In accordance with another aspect of the present disclosure, there is provided a deep learning model interference device, the device comprises: a memory configured to store a deep learning model and one or more instructions for performing inference using the deep learning model; and a processor configured to execute the one or more instructions stored in the memory, when executed by the processor, cause the processor to perform inference of the deep learning model, wherein the deep learning model is trained to: receive training data at a first time to obtain first output vectors and receive the training data at a second time before the first time to obtain second output vectors; generate soft target vectors at the first time with respect to the training data using the second output vectors and label data; sort the first output vectors and the soft target vectors and generate a first partial distribution for the sorted first output vectors and a second partial distribution for the sorted soft target vectors; and minimize a first loss function determined on the basis of the first partial distribution and the second partial distribution, wherein output according to input data of the same domain as the training data is generated using the pre-trained model.

In accordance with another aspect of the present disclosure, there is provided a transitory computer readable storage medium storing computer executable instructions, wherein the instructions, when executed by a processor, cause the processor to perform a deep learning model training method using a self-knowledge distillation algorithm, the method comprises: inputting training data to a deep learning model at a first time to obtain first output vectors and inputting the training data to the deep learning model at a second time before the first time to obtain second output vectors; generating soft target vectors at the first time point with respect to the training data using the second output vectors and label data; sorting the first output vectors and the soft target vectors and generating a first partial distribution for the sorted first output vectors and a second partial distribution for the sorted soft target vectors; and training the deep learning model to minimize a first loss function determined on the basis of the first partial distribution and the second partial distribution.

According to an embodiment of the present disclosure, it is possible to achieve the effect of improving the performance of a deep learning model by training the deep learning model such that learning of knowledge about high-confidence classes is enhanced and knowledge about low-confidence classes is not ignored without burdening high costs for additional models or additional calculations for learning.

In addition, according to an embodiment of the present disclosure, it is possible to achieve the effect of reducing a deep learning model development cost by improving the performance of a deep learning model without modifying the existing self-knowledge distillation algorithm using a plug-in method.

### BRIEF DESCRIPTION OF THE DRAWINGS

FIG. 1 is a block diagram showing a deep learning model training device according to an embodiment of the present disclosure.

FIG. 2 is a block diagram conceptually showing functions of a deep learning model training program according to an embodiment of the present disclosure.

FIG. 3 is a flowchart showing a deep learning model training method according to an embodiment of the present disclosure.

FIG. 4 is a flowchart showing a process of determining a first loss function according to an embodiment of the present disclosure.

FIG. 5 is a diagram showing a method of training a deep learning model on the basis of the first loss function and a second loss function determined according to an embodiment of the present disclosure.

FIG. 6 is a block diagram showing a deep learning model inference device according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

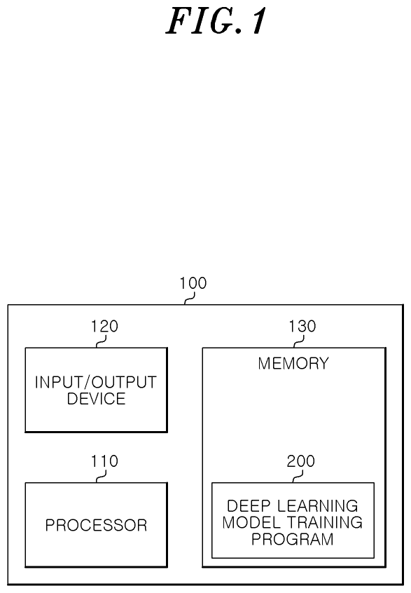

FIG. 1 is a block diagram showing a deep learning model training device according to an embodiment of the present disclosure.

Referring to FIG. 1, the deep learning model training device 100 may include a processor 110, an input/output device 120, and a memory 130.

The processor 110 may generally control the operation of the deep learning model training device 100.

The processor 110 may receive training data and label data using the input/output device 120. Here, the training data and label data according to an embodiment of the present disclosure may mean data for multiclass classification. For example, the training data may include images for classifying objects (e.g., cars, cats, etc.), and the label data may include data labeled for objects (e.g., cars, cats, etc.) in the images.

Although the training data and the label data are input through the input/output device 120 in the present disclosure, the present disclosure is not limited thereto. That is, depending on an embodiment, the deep learning model training device 100 may include a transceiver (not shown) and may receive at least one of training data and label data using the transceiver (not shown), and at least one of the training data and the label data may be generated in the deep learning model training device 100.

The processor 110 may obtain first output vectors by inputting training data to a deep learning model at a first time, obtain second output vectors by inputting the training data to the deep learning model at a second time before the first time, generate soft target vectors at the first time for the training data using the second output vectors and label data, sort the first output vectors and the soft target vectors, generate a first partial distribution with respect to the sorted first output vectors and a second partial distribution with respect to the sorted soft target vectors, and train the deep learning model to minimize a first loss function determined on the basis of the first partial distribution and the second partial distribution, thereby improving the performance of the deep learning model.

The input/output device 120 may include one or more input devices and/or one or more output devices. For example, input devices may include a microphone, a keyboard, a mouse, a touch screen, and the like, and output devices may include a display, a speaker, and the like.

The memory 130 may store a deep learning model training program 200 and information necessary for execution of the deep learning model training program 200.

In this specification, the deep learning model training program 200 may refer to software that receives training data and label data and includes instructions for improving the performance of a deep learning model using a self-knowledge distillation algorithm.

The processor 110 may load the deep learning model training program 200 and the information necessary for execution of the deep learning model training program 200 from the memory 130 in order to execute the deep learning model training program 200.

The processor 110 may execute the deep learning model training program 200 to improve the performance of a deep learning model using a self-knowledge distillation algorithm.

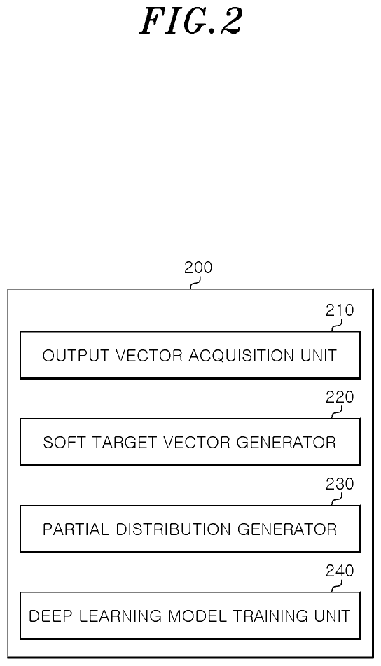

The functions and/or operations of the deep learning model learning program 200 will be examined in detail with reference to FIG. 2.

FIG. 2 is a block diagram conceptually showing functions of a deep learning model training program according to an embodiment of the present disclosure.

Referring to FIG. 2, the deep learning model training program 200 includes an output vector acquisition unit 210, a soft target vector generator 220, a partial distribution generator 230, and a deep learning model training unit 240.

The output vector acquisition unit 210, the soft target vector generator 220, the partial distribution generator 230, and the model training unit 240 shown in FIG. 2 are conceptually divided functions of the deep learning model training program 200 in order to easily describe the functions of the deep learning model training program 200, and the present disclosure is not limited thereto. According to embodiments, the functions of the output vector acquisition unit 210, the soft target vector generator 220, the partial distribution generator 230, and the deep learning model training unit 240 may be merged/separated and may also be implemented as a series of instructions included in a program.

First, the output vector acquisition unit 210 may acquire first output vectors by inputting training data to a deep learning model at a first time and acquire second output vectors by inputting the training data to the deep learning model at a second time before the first time. Here, the deep learning model according to an embodiment of the present disclosure may refer to a deep learning model using a known self-knowledge distillation technique.

Specifically, the first output vectors and the second output vectors according to an embodiment of the present disclosure are obtained by inputting the training data to the deep learning model at the first time and the second time, and may refer to distributions with respect to confidence (class probability or prediction confidence) regarding classification of given classes.

Meanwhile, the number of times of training the deep learning model corresponding to the first time and the number of times of training the deep learning model corresponding to the second time according to an embodiment of the present disclosure may be different from each other. For example, the number (epoch) of times of training the deep learning model corresponding to the first time may be 10, and the number of time of training the deep learning model corresponding to the second time before the first time may be 5.

Accordingly, at the time of training the deep learning model at the first point in point, the performance of the deep learning model can be improved without using an additional model such as a teacher model by using the deep learning model at the second time.

Next, the soft target vector generator 220 may generate soft target vectors at the first time for the training data using the second output vectors and label data.

Specifically, the soft target vector generator 220 according to an embodiment of the present disclosure generates the soft target vectors by performing a weighted sum operation on a label y and the second output vector z^{t}. Here, the soft target vectors s can be determined using mathematical expression 1 below.

$$s = ( 1 - α ) y + α \cdot {z}^{t} \qquad [ Mathematical expression 1 ]$$

Here, s represents the soft target vector at the first time for the training data, a represents a value between 0 and 1, y represents a label of the label data, and z′ represents the second output vector output when the training data is input to the deep learning model at the second time.

Next, the partial distribution generator 230 may sort the first output vectors and the soft target vectors and generate a first partial distribution with respect to the sorted first output vectors and a second partial distribution with respect to the sorted soft target vectors.

Specifically, the partial distribution generator 230 according to an embodiment of the present disclosure may sort the soft target vectors on the basis of confidence scores regarding multiclass classification. Here, a confidence score according to an embodiment of the present disclosure may mean a score expressed on the basis of normalization of confidence (or class probability value or prediction confidence) regarding classification of given classes.

For example, the partial distribution generator 230 may sort the soft target vectors in descending order of confidence or in ascending order of confidence with reference to the confidence score of each class included in the soft target vectors.

Additionally, the partial distribution generator 230 according to an embodiment of the present disclosure may sort the first output vectors in the same class order as the sorted soft target vectors.

For example, the partial distribution generator 230 may sort the first output vectors in the same order as the class order of the soft target vectors sorted in descending order of confidence or in ascending order of confidence.

Meanwhile, the partial distribution generator 230 according to an embodiment of the present disclosure may divide all classes included in the first output vectors and the soft target vectors by a preset number of classes to generate the first partial distribution and the second partial distribution.

Specifically, the partial distribution generator 230 according to an embodiment of the present disclosure may generate at least one first partial distribution and at least one second partial distribution (e.g., the number of first partial distributions and the number of second partial distributions are each 20) by dividing all classes included in the first output vectors and the soft target vectors (e.g., the total numbers of classes of the first output vectors and the soft target vectors are each 100) by a preset number of classes (e.g., the preset number of classes is 5) using a window with a specific size.

Meanwhile, the number of classes set to generate the first partial distribution and the second partial distribution is not limited to the above example and may be changed in various manners within a range in which the objects of the present disclosure can be achieved.

In addition, the partial distribution generator 230 according to an embodiment of the present disclosure may generate a first partial probability distribution and a second partial probability distribution from the first partial distribution and the second partial distribution using a softmax function.

Specifically, the partial distribution generator 230 may generate at least one first partial probability distribution using the softmax function for at least one first partial distribution, and generate at least one second partial probability distribution using the softmax function for at least one second partial distribution.

Accordingly, in the above-described deep learning model training process, partial distributions for classes classified according to confidence scores are generated as partial probability distributions having values between 0 and 1 regardless of confidence scores through the softmax function, and thus the effect of learning without ignoring the knowledge corresponding to low confidence scores can be achieved by considering a first partial distribution for a class corresponding to a low confidence score in a soft output vector and a second partial distribution for the class and a first partial distribution for a class corresponding to a high confidence score in the soft output vector and a second partial distribution for the class in the same manner.

Next, the deep learning model training unit 240 may train the deep learning model to minimize the first loss function determined on the basis of the first partial distribution and the second partial distribution.

Specifically, the first loss function according to an embodiment of the present disclosure may be determined on the basis of the difference (or distance) between the first partial probability distribution generated from the first partial distribution and the second partial probability distribution generated from the second partial distribution. For example, the first loss function may be a loss function based on Kullback-Leibler (KL) divergence or cross-entropy.

In addition, the deep learning model training unit 240 according to an embodiment of the present disclosure may determine a second loss function on the basis of the overall distributions of the first output vectors and the soft target vectors, and train the deep learning model to minimize a third loss function corresponding to a weighted sum of the first loss function and the second loss function.

Specifically, the deep learning model training unit 240 according to an embodiment of the present disclosure may determine the second loss function (e.g., the second loss function is a distillation loss function used in a conventional self-knowledge distillation algorithm) on the basis of the difference (or distance) between the overall distribution of the first output vectors and the overall distribution of the soft target vectors, and train the deep learning model to minimize the third loss function corresponding to a weighted sum of the first loss function and the second loss function.

Here, the third loss function can be expressed as mathematical expression 2 below.

$$L = {L}_{K D} + β \cdot {L}_{SCE} \qquad [ Mathematical expression 2 ]$$

Here, L represents the third loss function, LKD represents the second loss function, which is a distillation loss function used in a conventional self-knowledge distillation algorithm, L_{SCE} represents the first loss function, and ß represents a hyper parameter having a value between 0.01 and 0.1.

Accordingly, the effect of improving the performance of the deep learning model can be achieved by enhancing learning about knowledge about high-confidence classes and training the deep learning model such that knowledge about low-confidence classes is not ignored.

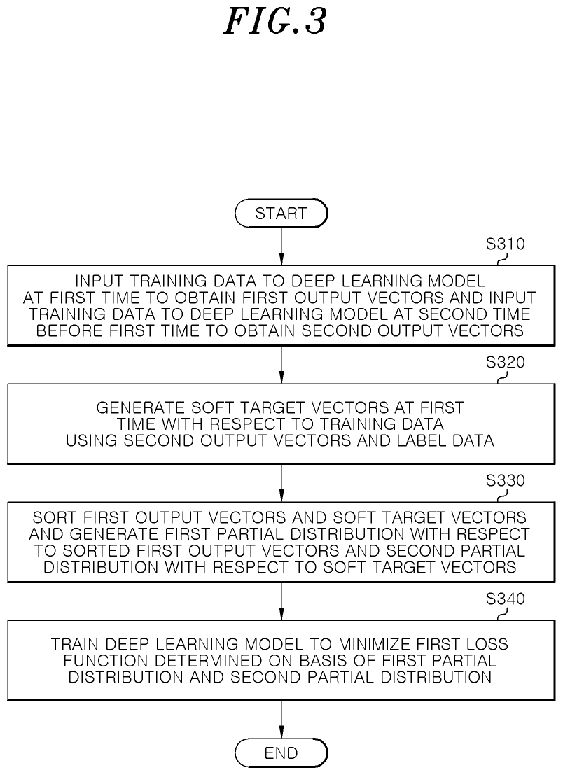

FIG. 3 is a flowchart showing a deep learning model training method according to an embodiment of the present disclosure.

Referring to FIG. 2 and FIG. 3, the processor 110 according to an embodiment of the present disclosure inputs training data to a deep learning model at a first time to obtain first output vectors, and inputs the training data to the deep learning model at a second time before the first time to obtain second output vectors (S310).

Next, the processor 110 may generate soft target vectors at the first time for the training data using the second output vectors and label data (S320).

Then, the processor 110 may sort the first output vectors and the soft target vectors and generate a first partial distribution with respect to the sorted first output vectors and a second partial distribution with respect to the sorted soft target vectors (S330).

Subsequently, the processor 110 may train the deep learning model to minimize a first loss function determined on the basis of the first partial distribution and the second partial distribution (S340).

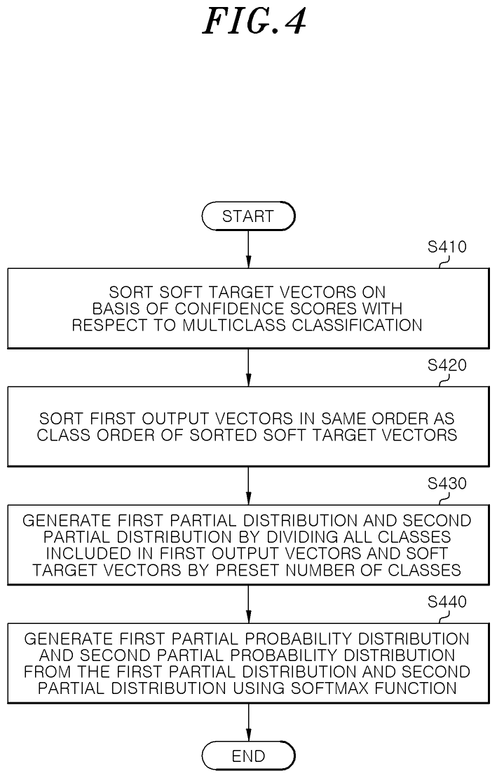

FIG. 4 is a flowchart showing a process of determining the first loss function according to an embodiment of the present disclosure.

Referring to FIG. 2 and FIG. 4, the processor 110 according to an embodiment of the present disclosure may sort soft target vectors on the basis of confidence scores with respect to multiclass classification (S410) and sort first output vectors in the same order as the class order of the sorted soft target vectors (S420).

Next, the processor 110 may divide all classes included in the first output vectors and the soft target vectors by a preset number of classes to generate a first partial distribution and a second partial distribution (S430), generate a first partial probability distribution and a second partial probability distribution from the first partial distribution and the second partial distribution using a softmax function (S440), and determine the first loss function on the basis of the difference between the first partial probability distribution and the second partial probability distribution (S450).

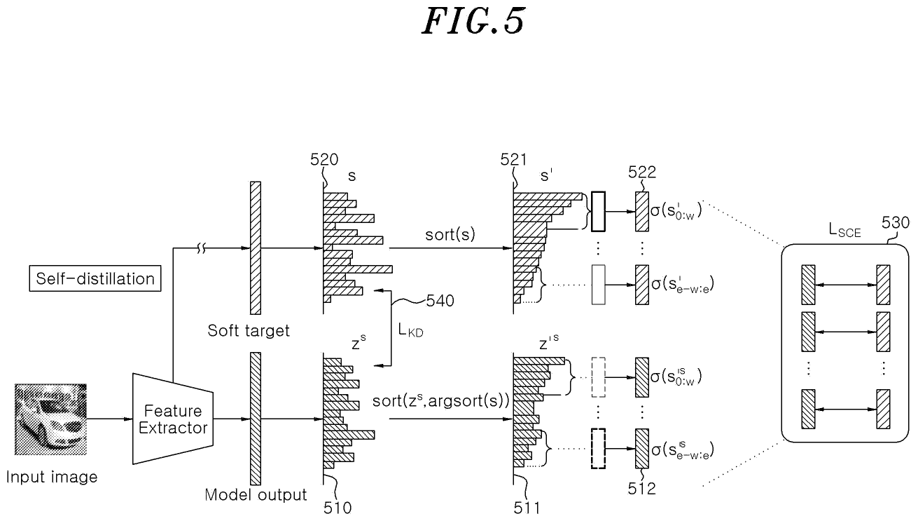

FIG. 5 is a diagram showing a method of training a deep learning model on the basis of the first loss function and the second loss function determined according to an embodiment of the present disclosure.

Referring to FIG. 2 and FIG. 5, the processor 110 according to an embodiment of the present disclosure may obtain first output vectors 510 by inputting a training image to a deep learning model at a first time. In addition, the processor 110 may obtain second output vectors by inputting the training image to the deep learning model at a second time before the first time, and generate soft target vectors 520 at the first time with respect to the training image using the second output vectors and a label image on the basis of a self-knowledge distillation algorithm.

Meanwhile, the processor 110 according to an embodiment of the present disclosure may sort the soft target vectors 520 in descending order of confidence on the basis of confidence scores for multiclass classification. Additionally, the processor 110 may sort the first output vectors 510 in the same class order as the sorted soft target vectors 521. Here, since the sorted first output vectors 511 are not sorted on the basis of confidence scores, it can be ascertained that, unlike the sorted soft target vectors 521, the distribution of the sorted first output vectors 511 is not smooth.

In addition, the processor 110 according to an embodiment of the present disclosure may generate at least one first partial distribution and at least one second partial distribution by dividing all classes included in the first output vectors and the soft target vectors by a preset number of classes using a window having a specific size. Additionally, the processor 110 may generate at least one first partial probability distribution 512 using a softmax function for at least one first partial distribution, and generate at least one second partial probability distribution 522 using the softmax function for at least one second partial distribution.

Additionally, the processor 110 according to an embodiment of the present disclosure may determine the first loss function 530 on the basis of the difference (or distance) between the at least one first partial probability distribution 512 and the at least one second partial probability distribution 522.

Meanwhile, the processor 110 according to an embodiment of the present disclosure may determine the second loss function 540 on the basis of the difference (or distance) between the overall distribution 510 of the first output vectors and the overall distribution 520 of the soft target vectors, and train a deep learning model by performing backpropagation to minimize the third loss function, which is a weighted sum of the first loss function and the second loss function. Here, in the third loss function according to an embodiment of the present disclosure, a greater weight may be assigned to the second loss function than to the first loss function.

Accordingly, the effect of improving the performance of a deep learning model can be achieved by enhancing learning about knowledge about high-confidence classes and training the deep learning model such that knowledge about low-confidence classes is not ignored without burdening high costs for additional models or additional calculations for learning.

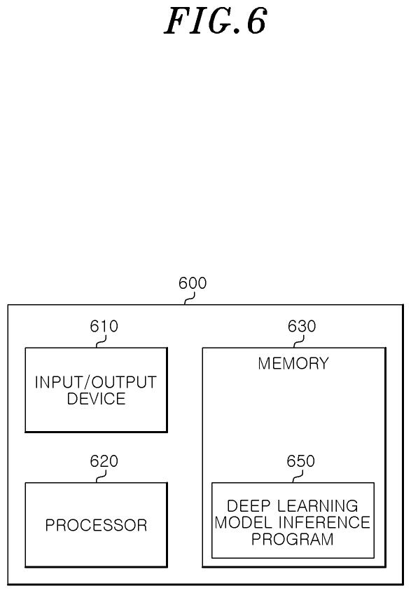

FIG. 6 is a block diagram showing a deep learning model inference device according to an embodiment of the present disclosure.

Referring to FIG. 6, the deep learning model inference device 600 may include a processor 610, an input/output device 620, and a memory 630.

The processor 610 can generally control the operation of the deep learning model inference device 600.

The processor 610 may receive input data using the input/output device 620.

Additionally, in the present disclosure, a deep learning model may be an artificial intelligence model that receives predetermined input data (e.g., image data, video data, etc.) and performs predetermined inference (e.g., data classification, image data classification, object detection, etc.).

Although input data is input through the input/output device 620 in the present disclosure, the present disclosure is not limited thereto. For example, the deep learning model inference device 600 may include a transceiver (not shown), and may receive input data using a transceiver (not shown).

The input/output device 620 may include one or more input devices and/or one or more output devices. For example, input devices may include a microphone, a keyboard, a mouse, a touch screen, etc., and output devices may include a display, a speaker, etc.

The memory 630 may store a deep learning model inference program 650 and information necessary for execution of the deep learning model inference program 650.

In this specification, the deep learning model inference program 650 may refer to software that receives input data and includes instructions for performing inference using a deep learning model.

The processor 610 may load the deep learning model inference program 650 and information necessary for execution of the deep learning model inference program 650 from the memory 630 in order to execute the deep learning model inference program 650.

The processor 610 may input input data to a deep learning model and check results inferred through the deep learning model by executing the deep learning model inference program 650. Here, the deep learning model may be a machine learning model trained by the deep learning model training device of FIG. 1 and FIG. 2 described above, and the input data may be data from the same domain as training data.

For example, the deep learning model may be a machine learning model configured and trained to receive training data at the first time to obtain first output vectors, to receive the training data at the second time before the first time to obtain second output vectors, to generate soft target vectors at the first time with respect to the training data using the second output vectors and label data, to sort the first output vectors and the soft target vectors, to generate a first partial distribution for the sorted first output vectors and a second partial distribution for the sorted soft target vectors, and to minimize a first loss function determined on the basis of the first partial distribution and the second partial distribution.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A deep learning model training method using a self-knowledge distillation algorithm, the method comprising:
inputting training data to a deep learning model at a first time to obtain first output vectors and inputting the training data to the deep learning model at a second time before the first time to obtain second output vectors;
generating soft target vectors at the first time point with respect to the training data using the second output vectors and label data;
sorting the first output vectors and the soft target vectors and generating a first partial distribution for the sorted first output vectors and a second partial distribution for the sorted soft target vectors; and
training the deep learning model to minimize a first loss function determined on the basis of the first partial distribution and the second partial distribution.

2. The deep learning model training method of claim 1, wherein a number of times of training the deep learning model at the first time and a number of times of training the deep learning model at the second time are different from each other.

3. The deep learning model training method of claim 1, wherein the generating the first partial distribution and the second partial distribution includes:
sorting the soft target vectors on the basis of confidence scores for multiclass classification; and
sorting the first output vectors in the same order as a class order of the sorted soft target vectors.

4. The deep learning model training method of claim 1, wherein the generating the first partial distribution and the second partial distribution includes generating the first partial distribution and the second partial distribution by dividing all classes included in the first output vectors and the soft target vectors by a preset number of classes.

5. The deep learning model training method of claim 1, further comprising generating a first partial probability distribution and a second partial probability distribution from the first partial distribution and the second partial distribution using a softmax function.

6. The deep learning model training method of claim 4, wherein the first loss function is determined on the basis of the difference between the first partial probability distribution and the second partial probability distribution.

7. The deep learning model training method of claim 1, wherein the training the deep learning model includes:
determining a second loss function on the basis of the overall distributions of the first output vectors and the soft target vectors; and
training the deep learning model to minimize a third loss function corresponding to a weighted sum of the first loss function and the second loss function.

8. A deep learning model interference device comprising:
a memory configured to store a deep learning model and one or more instructions for performing inference using the deep learning model; and
a processor configured to execute the one or more instructions stored in the memory, when executed by the processor, cause the processor to perform inference of the deep learning model,
wherein the deep learning model is trained to:
receive training data at a first time to obtain first output vectors and receive the training data at a second time before the first time to obtain second output vectors;
generate soft target vectors at the first time with respect to the training data using the second output vectors and label data;
sort the first output vectors and the soft target vectors and generate a first partial distribution for the sorted first output vectors and a second partial distribution for the sorted soft target vectors; and
minimize a first loss function determined on the basis of the first partial distribution and the second partial distribution,
wherein output according to input data of the same domain as the training data is generated using the pre-trained model.

9. The deep learning model inference device of claim 8, wherein the number of times of training the deep learning model at the first time and the number of times of training the deep learning model at the second time are different from each other.

10. The deep learning model inference device of claim 8, wherein the deep learning model is trained to sort the soft target vectors on the basis of confidence scores for multiclass classification and to sort the first output vectors in the same order as a class order of the sorted soft target vectors.

11. The deep learning model inference device of claim 8, wherein the deep learning model is trained to generate the first partial distribution and the second partial distribution by dividing all classes included in the first output vectors and the soft target vectors by a preset number of classes.

12. The deep learning model inference device of claim 8, wherein the deep learning model is trained to generate a first partial probability distribution and a second partial probability distribution from the first partial distribution and the second partial distribution using a softmax function.

13. The deep learning model inference device of claim 12, wherein the first loss function is determined on the basis of the difference between the first partial probability distribution and the second partial probability distribution.

14. The deep learning model inference device of claim 8, wherein the deep learning model is trained to determine a second loss function on the basis of the overall distributions of the first output vectors and the soft target vectors and to minimize a third loss function corresponding to a weighted sum of the first loss function and the second loss function.

15. A non-transitory computer readable storage medium storing computer executable instructions, wherein the instructions, when executed by a processor, cause the processor to perform a deep learning model training method using a self-knowledge distillation algorithm, the method comprising:
inputting training data to a deep learning model at a first time to obtain first output vectors and inputting the training data to the deep learning model at a second time before the first time to obtain second output vectors;
generating soft target vectors at the first time point with respect to the training data using the second output vectors and label data;
sorting the first output vectors and the soft target vectors and generating a first partial distribution for the sorted first output vectors and a second partial distribution for the sorted soft target vectors; and
training the deep learning model to minimize a first loss function determined on the basis of the first partial distribution and the second partial distribution.

16. The non-transitory computer-readable recording medium of claim 15, wherein the number of times of training the deep learning model at the first time and the number of times of training the deep learning model at the second time are different from each other.

17. The non-transitory computer-readable recording medium of claim 15, wherein the generating the first partial distribution and the second partial distribution includes:
sorting the soft target vectors on the basis of confidence scores for multiclass classification; and
sorting the first output vectors in the same order as a class order of the sorted soft target vectors.

18. The non-transitory computer-readable recording medium of claim 15, wherein the generating of the first partial distribution and the second partial distribution includes generating the first partial distribution and the second partial distribution by dividing all classes included in the first output vectors and the soft target vectors by a preset number of classes.

19. The non-transitory computer-readable recording medium of claim 18, wherein the first loss function is determined on the basis of the difference between a first partial probability distribution generated from the first partial distribution and a second partial probability distribution generated from the second partial distribution.

20. The non-transitory computer-readable recording medium of claim 15, wherein the training of the deep learning model comprises:
determining a second loss function on the basis of the overall distributions of the first output vectors and the soft target vectors; and
training the deep learning model to minimize a third loss function corresponding to a weighted sum of the first loss function and the second loss function.
